(19) United States
(12) Patent Application Publication
(10) Pub. No.: US 2005/0279865 A1
(43) Pub. Date: Dec. 22, 2005

(54) Fluid spraying system

(75) Inventors: Scott Thomason, Macedonia, OH (US); Nicholas Mastandrea, Newbury, OH (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(73) Assignee: Innovative Developments, LLC

(21) Appl. No.: 11/151,995

(22) Filed: Jun. 14, 2005

Related U.S. Application Data
(60) Provisional application No. 60/581,219, filed on Jun. 18, 2004.

(51) Int. Cl. E01H 3/02; E01C 19/16; A01G 25/09; B05B 9/03; A62C 13/62; A62C 13/66; B05B 7/02; B05B 9/01

(52) U.S. Cl. 239/526; 239/302; 239/525

(57) ABSTRACT

A sunless tanning system is provided that includes a base unit and a handheld sprayer assembly fluidly coupled to each other via at least one hose. The base unit includes at least one fluid reservoir configured to contain a sunless tanning solution. The handheld sprayer assembly includes an activation device configured to activate the sunless tanning system and a nozzle in fluid communication with the at least one fluid reservoir. The nozzle is configured to eject tanning solution onto an application surface upon activation of the activation device.

### CROSS-REFERENCE TO RELATED APPLICATION

This application claims the benefit of priority of U.S. Provisional Application No. 60/581,219 filed on Jun. 19, 2004, which is hereby incorporated by reference in its entirety herein.

### BACKGROUND

Numerous forms of artificial tanning products are currently available, including lotions, creams, gels, oils, and sprays. These products are typically mixtures of a chemically-active skin colorant or a bronzer, in combination with moisturizers, preservatives, anti-microbials, thickeners, solvents, emulsifiers, fragrances, surfactants, stabilizers, sunscreens, pH adjusters, anti-caking agents, and additional ingredients to alter the color reaction.

Automated systems for applying artificial tanning products often include a booth provided with a spraying system. The user selects a tanning shade and intensity before the process begins, then steps inside the booth. Once the user is inside, the spraying system is activated and the user is uniformly coated.

### BRIEF DESCRIPTION OF THE DRAWINGS

In the accompanying drawings and descriptions that follow, like parts are indicated throughout the drawings and description with the same reference numerals, respectively. One of ordinary skill in the art will appreciate that one element can be designed as multiple elements or that multiple elements can be designed as one element. An element shown as an internal component of another element can be implemented as an external component and vice versa. The figures are not drawn to scale and the proportions of certain parts have been exaggerated for convenience of illustration.

FIG. 1 is a simplified perspective view of one embodiment of a fluid spraying system 100;

FIG. 2 is a simplified reverse perspective view of the fluid spraying system 100;

FIG. 3 is a simplified schematic view of one embodiment of the internal components of the fluid spraying system 100;

FIG. 4 is a side view of one embodiment of a fluid container 120;

FIG. 5 is a simplified perspective view of one embodiment of the fluid spraying system 100 with a door removed from the base unit 102 to expose the fluid containers;

FIG. 6 is a simplified perspective view of the interior of the base unit 102 of one embodiment of the fluid spraying system 100;

FIG. 7A is a perspective view of the sprayer assembly 104;

FIG. 7B is a perspective view of the sprayer assembly 104 and an optional attachment accessory 160;

FIGS. 8A and 8B are flow charts illustrating one method 200 for operating the fluid spraying system 100 that can be employed by a controller; and

FIG. 9 is a flow chart illustrating one method 300 for applying a solution to a human body that can be employed by an operator of the fluid spraying system 100.

### DETAILED DESCRIPTION

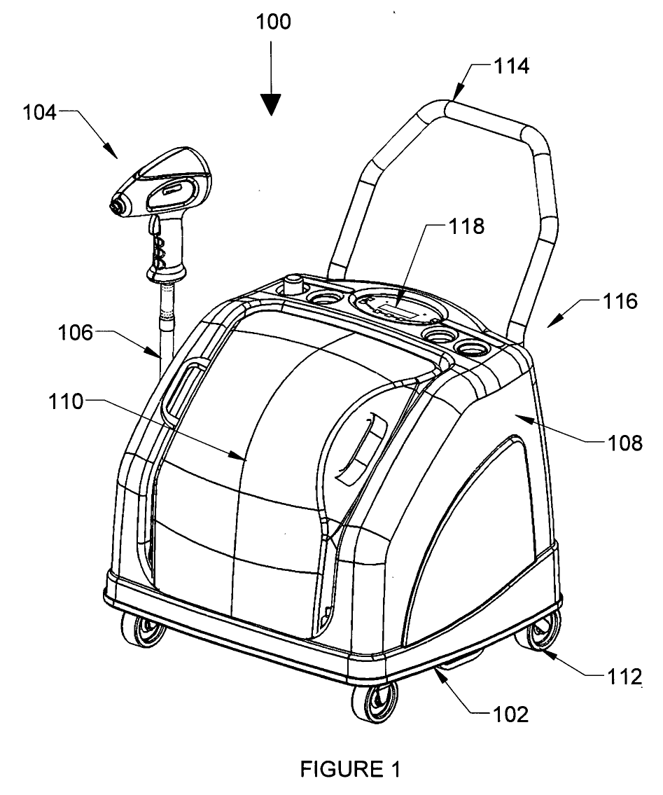

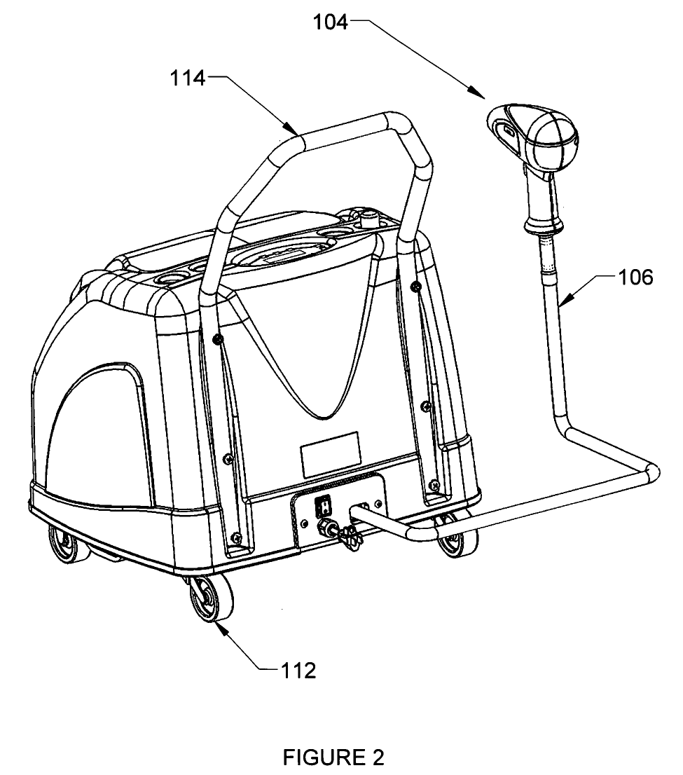

FIGS. 1 and 2 illustrate front and rear perspective views, respectively, of one embodiment of a fluid spraying system 100. The system 100 includes a base unit 102 configured to house fluid containers or reservoirs (not shown) and a handheld sprayer assembly 104 in fluid communication with the fluid reservoirs or containers via a hose 106. The system 100 is configured to spray a fluid onto an application surface.

In a preferred embodiment, the fluid spraying system 100 can be employed as a sunless tanning spraying system where it is configured to spray a sunless-tanning solution onto a human body. Exemplary sunless-tanning solutions include one or more colorants, such as dihydroxyacetone, crotonaldehyde, pyruvaldehyde, glycolaldehyde, glutaraldehyde, othophthaldehyde, sorbose, fructose, erythrulose, methylvinylketone, food coloring, or any other available colorant. The sunless-tanning solutions can additionally or alternatively include one or more bronzers, such as lawsone, juglone, or any other available bronzer. It will be appreciated that the sunless-tanning solutions can include additional ingredients, such as moisturizers and scents, to make the solution more appealing to a user.

While the preferred embodiment can be employed as a sunless tanning spray system, the system 100 can also be employed to spray other fluids onto the human body. For example, the system 100 can be configured to spray sunscreens, suntan lotions, tanning accelerators, sunburn treatments, insect repellants, skin toners, skin bleaches, skin lighteners, anti-microbial compositions, moisturizers, exfoliants, nutriments or vitamins, massage aides, muscle relaxants, skin treatment agents, burn treatment agents, decontamination agents, cosmetics, or wrinkle treatments or removers.

In one embodiment as shown in FIGS. 1 and 2, the base unit 102 can be in the form of a mobile cart that includes a support platform (not shown), a housing 108, and a door 110 configured to allow a user to access the fluid containers (not shown) housed in the base unit 102. Optionally, the mobile cart can include a plurality of wheels 112, a push handle 114, and a holder tray 116. The holder tray 116 can be contoured, as shown in FIG. 2, to hold the sprayer assembly 104 in either a sideways or downward orientation. An input/output device 118 such as an LCD touchpad display can be located on the top portion of the mobile cart to provide information to and accept commands from the user.

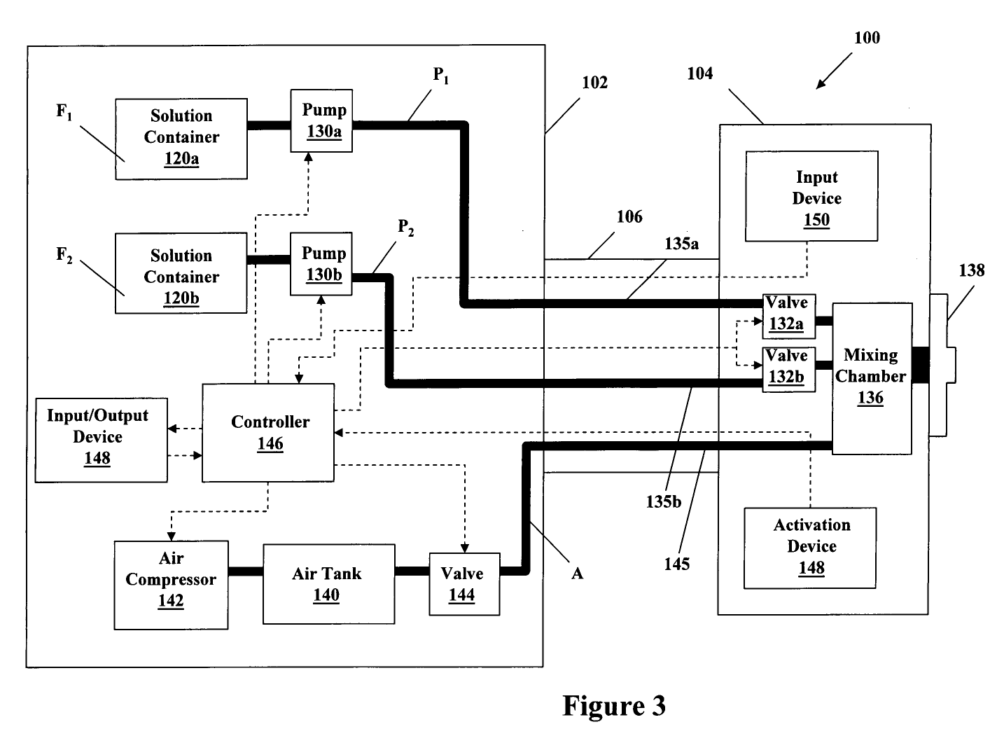

FIG. 3 is a simplified schematic depicting the internal components of one embodiment of the fluid spraying system 100. In this embodiment, the system 100 includes first and second fluid containers 120a,b provided in the base unit 102. The first and second fluid containers 120a,b are each configured to hold a fluid. For example, the first and second fluid containers 120a,b hold a first fluid F₁ and a second fluid F₂, respectively. It will be appreciated that the base unit 102 can house a single fluid container or more than two fluid containers.

In one embodiment, the fluid containers 120a,b can hold sunless-tanning solutions as described above. For example, each fluid container 120a,b can hold a different sunless-tanning solution. The different tanning solutions can have different chemical compositions which effect the hue of the resulting tan. Alternatively, one fluid container (e.g., the first fluid container 120a) can contain water or another dilution agent to dilute the tanning solution contained in the second solution container (e.g., the second fluid container 120b). The contents of the different fluid containers can be mixed in various combinations to provide a range of shades, thereby allowing the user to select a preferred tanning shade. It will be appreciated that the fluid containers 120a,b can the same sunless-tanning solution.

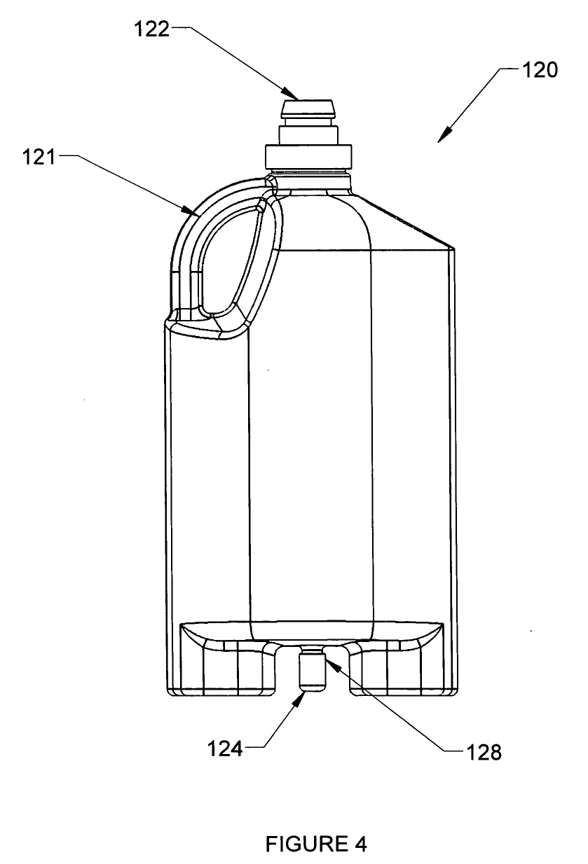

FIG. 4 illustrates a side view of one embodiment of a fluid container 120. In this embodiment, the fluid container 120 includes a handle 121, a male quick disconnect valve 122 at an opening located at one end portion of the fluid container 120, and a vent 124 provided at the other end portion of the fluid container 120. The fluid container 120 can also include a check valve 128 to ensure that fluid flows in only one direction such that, when the fluid container 120 is empty, the check valve 128 will prevent any residual solution from leaking out when the fluid container 120 is removed. It will be appreciated that the fluid container 120 can be configured differently in shape and size from the one illustrated in FIG. 4. Also, it will be appreciated that different fittings such as interchange couplings, poppet couplings, or threaded couplings, can be used to dispense solution from the fluid container 120.

In one embodiment, the fluid containers 120a,b are removable. Alternatively, the base unit 102 can house fixed fluid containers that can be filled with a fluid while still in the base unit 102 when the fluid level falls below a predetermined threshold.

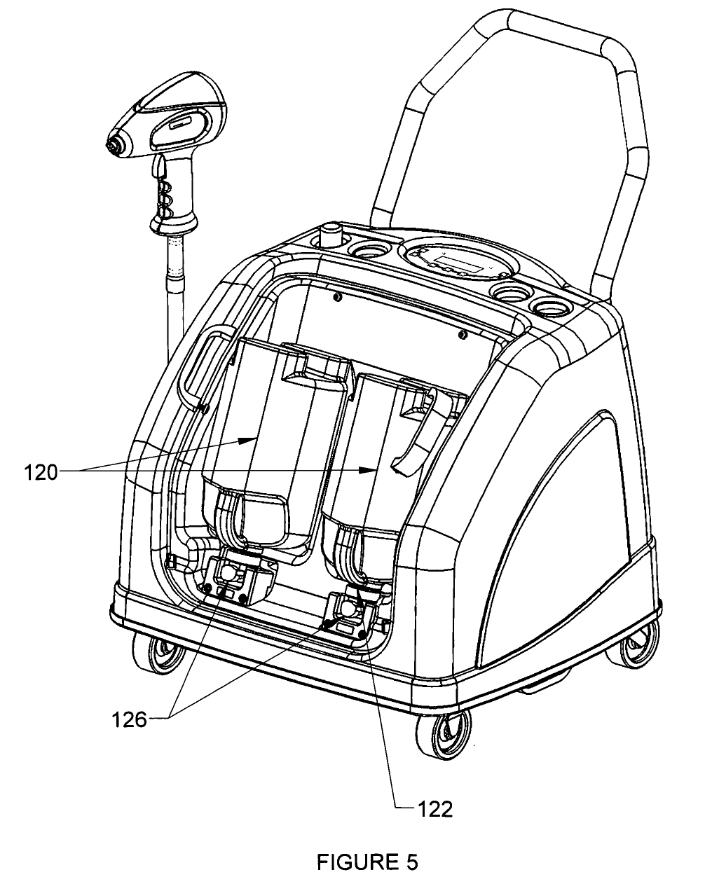

FIG. 5 illustrates a simplified perspective view of the fluid spraying system 100 with the door 110 removed to expose the fluid containers 120a,b. As shown in FIG. 5, each fluid container 120a,b is inverted such that the male quick disconnect valve 122 mates with a female quick disconnect fitting 126 disposed in the base unit 102. When a new fluid container 120 is added to the system 100, the male quick disconnect valve 122 of the fluid container 120 is snapped into the female quick disconnect fitting 126 in the base unit 102. The vent 124 on the fluid container 120 can then be opened to equalize the air pressure inside the fluid container 120, allowing fluid to flow freely.

With reference back to FIG. 3, the system 100 can include first and second pumps 130a,b provided in the base unit 102. The first pump 130a is configured to pump the first fluid F₁ held in the first fluid container 120a along a fluid flow path P₁ through the hose 106 to the sprayer assembly 104, while the second pump 130b is configured to pump the second fluid F₂ held in the second fluid container 120b along a fluid flow path P₂ through the hose 106 to the sprayer assembly 104. In one embodiment, the pumps 130a,b are positive displacement pumps. It will be appreciated, however, that any other type of fluid pump may suffice.

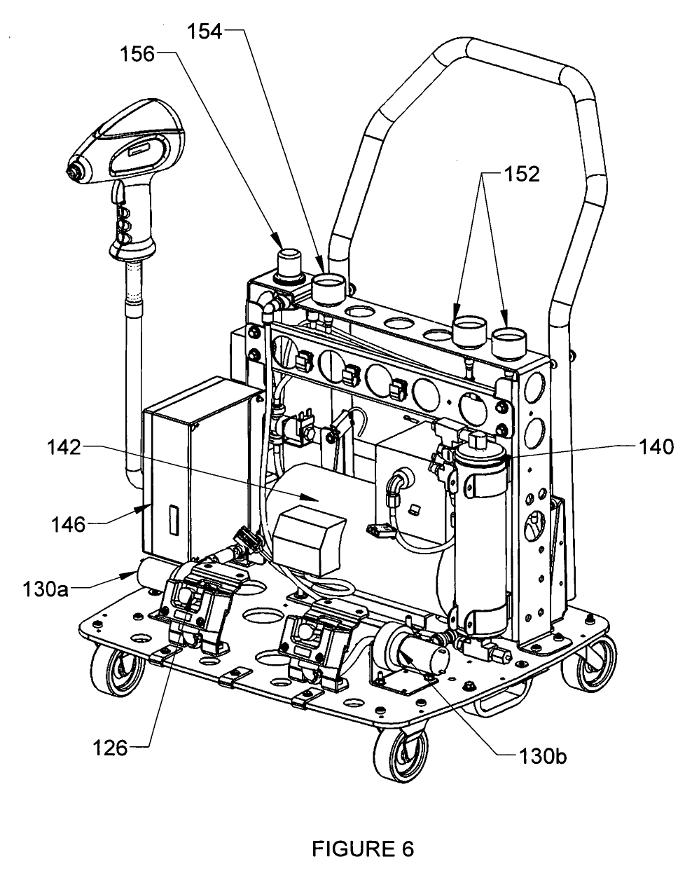

FIG. 6 illustrates a simplified perspective view of the interior of the base unit 102 in one embodiment of the fluid spraying system 100. As shown in FIG. 6, the first and second pumps 130a,b are positioned adjacent to the first and second fluid containers 120a,b, (not shown) respectively. It will be appreciated, however, that one or both of the pumps 130a,b can be positioned anywhere in the base unit 102.

With reference back to FIG. 3, the fluid spraying system 100 can include first and second solution valves 132a,b provided in the sprayer assembly 104. The first valve 132a is provided along the fluid flow path P₁ upstream from the first pump 130a, while the second valve 132b is provided along the fluid flow path P₂ upstream from the second pump 130b. The valves 132a,b are configured to control fluid flow along their respective fluid flow paths P₁, P₂. For example, when the valves 132a,b are in an “open” position, fluid is permitted to flow therethrough. When the valves 132a,b are in a “closed” position, fluid is not permitted to flow therethrough. In one embodiment, the valves 132a,b are solenoid valves. It will be appreciated, however, that any other type of controllable valve may be utilized.

As discussed above, the hose 106 couples the base unit 102, which contains the pumps 130a,b, to the sprayer assembly 104, which contains the valves 132a,b. Specifically, the hose 106 contains first and second hoses or tubes 135a,b that fluidly couple the first and second pumps 130a,b to the first and second valves 132a,b, respectively, as shown in FIG. 3.

With continued reference to FIG. 3, the fluid spraying system 100 can further include a mixing chamber 136 and a nozzle 138 provided in or on the sprayer assembly 104. The mixing chamber 136 is provided along the fluid flow paths P₁, P₂ upstream from the first and second solenoid valves 134a,b, while the nozzle 138 is provided upstream from the mixing chamber 138. The mixing chamber 136 is configured to permit the first and second fluids F₁, F₂ flowing along the fluid flow paths P₁, P₂, respectively, to combine and/or mix therein. For example, if the first and second fluids F₁, F₂ employed in the system 100 are different fluids, the two fluids can combine and/or mix in the mixing chamber 136 before entering the nozzle 138. The nozzle 138 is configured to eject the fluid, which is combined in the mixing chamber 136, onto an application surface.

In one embodiment, the fluid spraying system 100 can include an air tank 140 and an air compressor 142 provided in the base unit 102, as illustrated in FIG. 3. The air compressor 142 is configured to compress the air stored in the air tank 140 to provide a pressurized source of air along an air flow path A, which extends from the air compressor 142 through the hose 106 to the sprayer assembly 104. This air can then be used to atomize the first and second fluids F₁, F₂ that is ejected from the nozzle 138.

With continued reference to FIG. 3, the fluid spraying system 100 can include an air valve 144 provided in the base unit 102. The valve 144 is configured to control air flow along the air flow path A. For example, when the valve 144 is in an “open” position, air is permitted to flow therethrough. When the valve 144 is in a “closed” position, air is not permitted to flow therethrough. In one embodiment, the valve 144 can be a solenoid valve, although any other type of controllable valve may suffice.

As discussed above, the hose 106 couples the base unit 102, which contains the air tank 140, the air compressor 142, and the air valve 144, to the sprayer assembly 104, which contains the nozzle 138. Specifically, the hose 106 contains a hose or tube 145 that fluidly couples the air compressor 142 to the nozzle 138.

As shown in FIG. 3, the air flow path A terminates at the mixing chamber 136 or at nozzle exit 138. In the mixing chamber 136 or at the nozzle exit 138, the pressurized air combines and/or mixes with at least one fluid when one or both of the valves 132a,b and the valve 144 are in the open position. The combination and/or mixture of pressurized air and fluid creates an atomized mist of fluid that is ejected from the nozzle 138.

In one embodiment, the fluid spraying system 100 can include a controller 146 provided in the base unit 102 as shown in FIG. 3. The controller 146 is configured to control the operation of the fluid spraying system 100. Specifically, the controller 146 is configured to operate the pumps 130a,b, the solution valves 132a,b, the air compressor 142, and the air valve 144. Suitable controllers can include a processor, a microprocessor, a control circuit, a PLC, or any other appropriate control device.

With continued reference to FIG. 3, the fluid spraying system 100 can include an activation device 148 provided on the sprayer assembly 104. The activation device 148 is configured to activate the sprayer assembly 104 to eject fluid from the nozzle 138. The activation device 148 is in signal communication with the controller 146 via electronic cables or wires provided in the hose 106. Alternatively, the activation device 148 can communicate with the controller 146 through radio signals, infrared signals, or other wireless communication means. The activation device 148 can be in the form of a trigger switch, a dial, a toggle switch, a lever, a knob, a button, or any other appropriate device.

In one embodiment, the fluid spraying system 100 can include an input device 150 provided on the sprayer assembly 104 as shown in FIG. 3. The input device 150 is configured to control the spray intensity of the fluid through the nozzle 138. The input device 150 is in signal communication with the controller 146 via electronic cables or wires provided in the hose 106. Alternatively, the input device 150 can communicate with the controller 146 through radio signals, infrared signals, or other wireless communication means. The input device 150 can take the form of one or more dials, toggle switches, levers, knobs, buttons, or any other appropriate control device.

Alternatively, the sprayer assembly 104 would not include an input device. Instead, the activation device 148 can be further configured to adjust spray intensity. For example, the activation device 148 can be a trigger switch configured such that the intensity of the spray is increased as the trigger is further depressed. In another embodiment, the sprayer assembly 104 can employ a dial (not shown) configured to activate the sprayer assembly 104 and control the intensity of the spray. In this embodiment, a user can rotate the dial to a first position to activate the fluid spraying system 100 at a low intensity level, then further rotate the dial to increase the spray intensity.

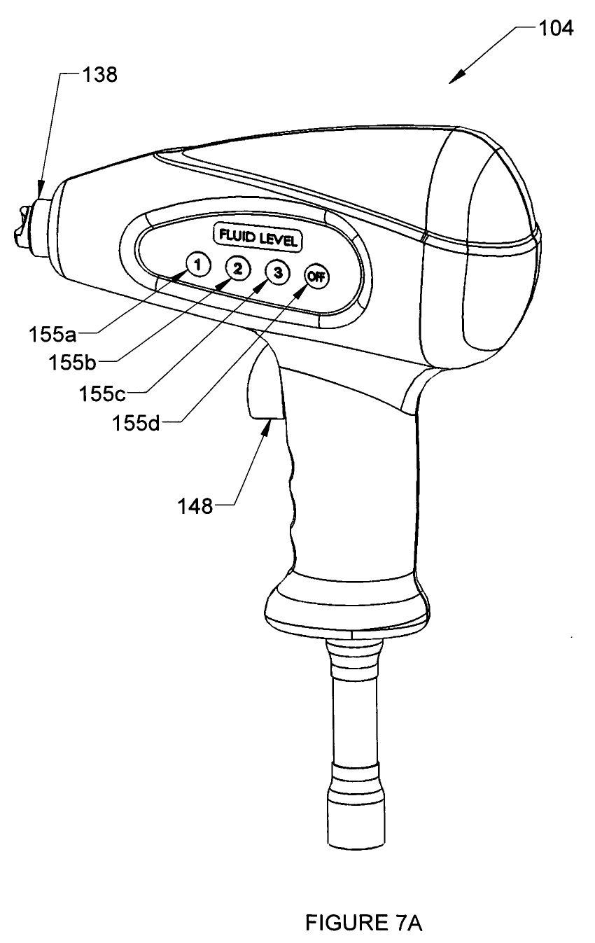

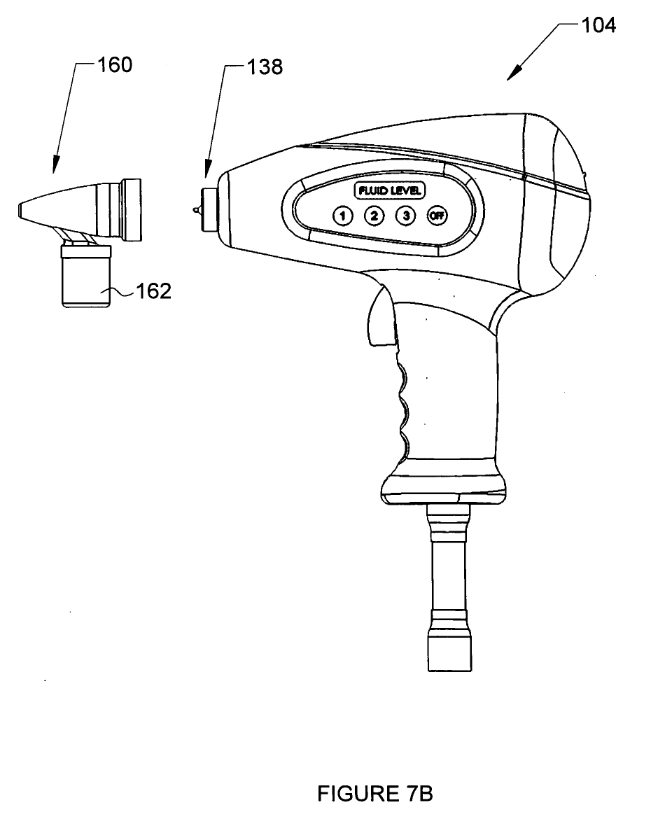

FIG. 7A illustrates a detailed perspective view of one embodiment of the sprayer assembly 104. In one embodiment, the activation device 148 can take the form of a trigger switch and the input device 150 can take the form of four pushbuttons 155a-d disposed along the side of the sprayer assembly 104 as shown in FIG. 7A. In the exemplary embodiment, each pushbutton 155a-d can be configured to transmit a selection of a pre-set intensity level to the controller 146. For example, a first pushbutton 155a can be activated to select a low intensity level, a second pushbutton 155b can be activated to select a medium intensity level, a third pushbutton 155c can be activated to select a high intensity level, and a fourth pushbutton 155d can be activated to select an intensity level of zero. If the user selects an intensity level of zero, the controller 146 will not operate the pumps 130a,b, but will operate the air compressor 142 so that only air is sprayed through the nozzle 138. Additionally, the pushbuttons can be programmable by the user.

With reference back to FIG. 3, the fluid spraying system 100 can include an input/output device 118 such as an LCD touchpad display provided on the base unit 102 to allow a user to select a ratio of solutions to create a desired solution mixture. In one embodiment, the LCD touchpad display can also be configured to allow a user to select a spray intensity level or can be used to program the push buttons 155a-d provided on the sprayer assembly 104 for spraying intensity level. The LCD touchpad display is in signal communication with the controller 146. It will be appreciated that in addition to, or instead of, the LCD display, an input device can be provided on the sprayer assembly 104 to allow a user to select a desired solution mixture.

Furthermore, it will be appreciated that the LCD touchpad display can perform additional functions. For example, the LCD touchpad display can be used to track an operator name, spray time, and solution usage and store this data in memory. The LCD touchpad display can also monitor all output functions including, but not limited to, air pressure, solution pressure, pump currents, and solenoid valve operation.

It will also be appreciated that the fluid spraying system 100 can include additional input or output devices disposed on the base unit 102. For example, as shown in FIG. 6, fluid pressure gauges 152 are provided at the top of the base unit 102 to indicate the fluid pressure of each fluid in the fluid containers 120a,b. Also, an air pressure gauge 154 can be provided at the top of the base unit 102 to indicate the air pressure. Additionally, an air pressure regulator 156 can be provided at the top of the base unit 102 to allow the user to regulate the air pressure.

In an alternative embodiment not illustrated in the drawings, an atomized spray of fluid can be created without the use of compressed or pressurized air. In this embodiment, the fluid spraying system 100 would not include the air tank 140, the air compressor 142, or the air valve 144. Instead, the system 100 would include a high pressure pump (not shown) for each fluid container 120a,b and the sprayer assembly 104 would employ a hydraulic atomizing nozzle (not shown) to create an atomized mist of fluid. It will be appreciated that this embodiment be used with a single fluid container or more than two fluid containers.

In an alternative embodiment not illustrated in the drawings, an atomized spray of fluid can be created without the use of compressed air. In this embodiment, the fluid spraying system 100 would not include the air tank 140 or the air compressor 142. Instead, the system 100 may include an HVLP (high velocity/low pressure) fan (not shown) in connection with the air valve 144 (optional in this embodiment). The air flow from this fan would be in fluid communication with the nozzle 138. This air flow may be used to atomize the fluid at the nozzle 138.

The fluid spraying system 100 can include additional components without departing from the scope of the present application. For example, the system 100 can include fluid detection sensors 158 disposed near the bottom of each fluid container 120a,b as shown in FIG. 6. The fluid detection sensors 158 are configured to sense the solution level in each fluid container 120a,b. When the solution level falls below a predetermined threshold, the fluid detection sensors 158 can be configured to transmit a signal to the controller 146. Upon receipt of the signal, the controller 146 can deactivate the fluid spraying system 100 to prevent air from being pulled into one or both of the fluid flow paths P₁, P₂. Exemplary fluid detection sensors that can be employed include capacitive solution detection switches, optical sensors, or piezoelectric sensors.

Also, the fluid spraying system 100 can include a heating element (not shown), such as a heating coil or other heating device, that can be placed around or adjacent to the first and/or second fluid tubes 135a,b to heat the fluid flow paths P₁, P₂, thereby creating a warm, atomized mist of fluid that can be ejected from the nozzle 138. Additionally, a heating element can be placed around or adjacent to the air tube 145 to heat the air flow path A. Alternatively, heating elements can be placed around or adjacent to one or both of the fluid containers 120a,b.

In yet another embodiment, the base unit 102 can include a power switch (not shown) to activate the controller 146. The power switch can be of the form of a toggle switch, a dial, a knob, a pushbutton, or any other appropriate device. In one embodiment, the power switch can be further configured to activate the air compressor 142. Therefore, in this embodiment, the activation of the trigger switch 146 would not cause the activation of the air compressor 142, nor would the release of the trigger switch cause the deactivation of the air compressor 142.

In yet another embodiment, the fluid spraying system 100 can include an attachment accessory 160 as shown in FIG. 7B. The attachment accessory 160 is configured to be removably attached to the nozzle 138 of the sprayer assembly 104 via a threaded connection. The attachment accessory 160 includes an auxiliary fluid reservoir 162 that is configured to contain an auxiliary fluid. The attachment accessory 160 is configured to channel air from the sprayer assembly through the tip of the nozzle 138 and adjustably siphon the auxiliary fluid from the auxiliary fluid reservoir 162 so that the auxiliary fluid can be sprayed onto an application surface. Exemplary auxiliary fluids include temporary tattoo dye, paint, other tanning solutions, or any other media that can and is desired to be sprayed.

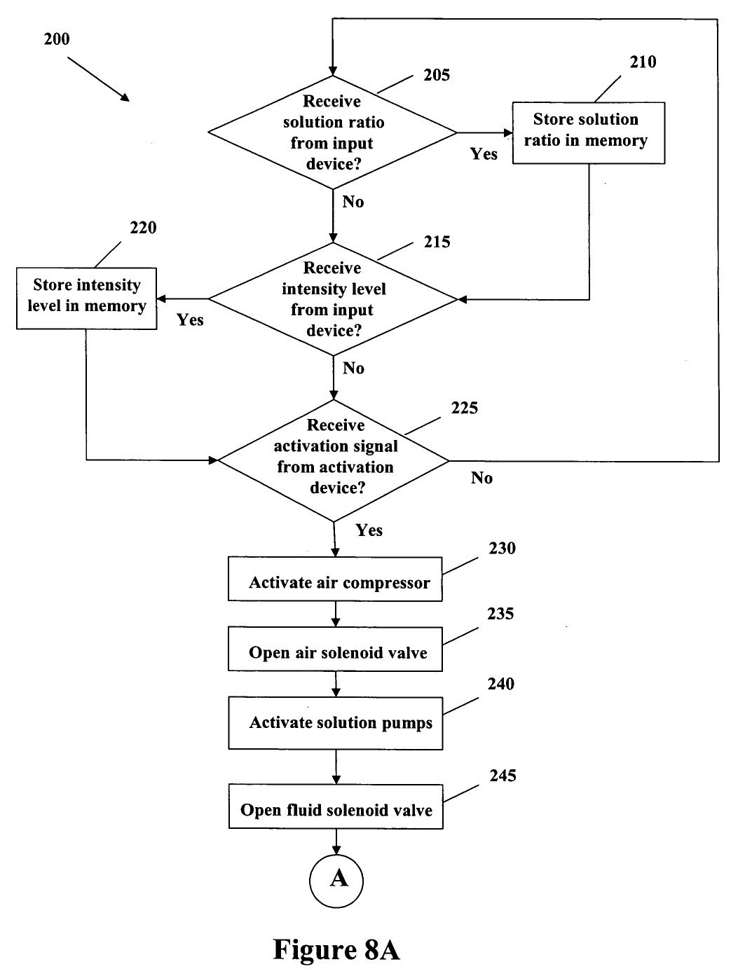

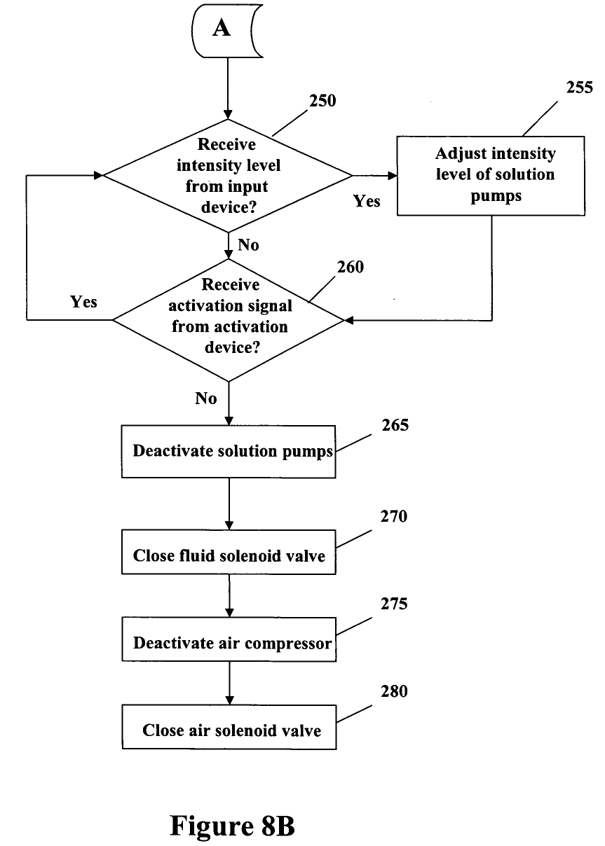

FIGS. 8A and 8B illustrate a flow chart diagram of an exemplary method 200 for operating the fluid spraying system 100 employed by the controller 146. The controller initially waits for a user to input a desired fluid ratio (step 205). If the user selects a fluid ratio via an input device, the input device transmits a signal to the controller, and the controller stores the selected fluid ratio in a memory (step 210). The controller also waits for a user to input an intensity level (step 215). If the user selects an intensity level via an input device, the input device transmits a signal to the controller, and the controller stores the selected intensity level in a memory (step 220). It will be appreciated that the fluid spraying system can employ a single input device, such as an LCD touchpad, to receive input related to the fluid ratio and spray intensity. Alternatively, the fluid spraying system can employ separate input devices, such as an LCD touchpad disposed on the base to receive input related to the fluid ratio and pushbuttons disposed on the sprayer assembly to receive input related to the spray intensity.

The controller also waits for the user to activate the fluid spraying system (step 225). When the user activates an activation device, the activation device transmits a signal to the controller. Upon receipt of the signal from the activation device, the controller activates the air compressor (step 230) and opens the air solenoid valve (step 235) to allow air to spray from the air tank through the nozzle of the sprayer assembly via a hose. The controller then activates the pumps (step 240). If the user has selected a fluid ratio and/or an intensity level, the controller operates the pumps according to the levels stored in the memory. If the user has not made a selection prior to activation, the controller can be programmed to operate the pumps at default levels or at the levels last stored during a prior operation of the fluid spraying system. The controller then opens appropriate fluid solenoid valves (step 245). However, it will be appreciated that steps 230-245 can be performed in any order.

If the user has selected a fluid ratio that includes both fluids, the two fluids and the compressed air mix in a mixing chamber in the sprayer assembly to create an atomized mist that sprays through the nozzle of the sprayer assembly. If the user has selected a single fluid, the single fluid and the compressed air mix in the mixing chamber in the sprayer assembly to create an atomized mist that sprays through the nozzle of the sprayer assembly.

During operation of the sprayer assembly, the user can select a different intensity level (step 250). If the user inputs a new intensity level, the input device will transmit a signal to the controller, and the controller will adjust the intensity level of the pumps (step 255). The fluid spraying system will continue to spray fluid for as long as the user activates the activation device (step 260). When the trigger switch is released, or the activation device is otherwise deactivated, the controller deactivates the pumps (step 265) and closes the fluid solenoid valves (step 270). The controller then deactivates the air compressor (step 275) and closes the air solenoid valve (step 280) to stop the spraying. It will be appreciated that steps 265-280 can be performed in any order.

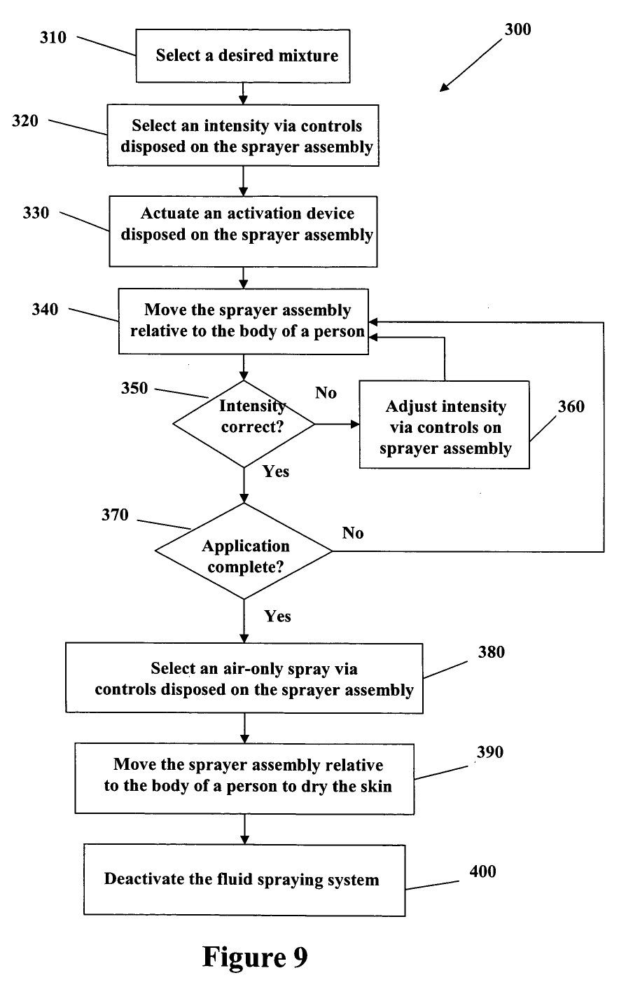

FIG. 9 illustrates a flow chart diagram of one method 300 for applying a solution (such as a sunless tanning solution) to a human body that can be employed by an operator of the fluid spraying system 100. In the illustrated method of operation, the operator can transport the fluid spraying system to a recipient's home or any other location. The operator or recipient selects a solution ratio according to the recipient's preference by using an LCD touchpad display or other appropriate input device (step 310). The operator or recipient then selects a spray intensity level by pressing an appropriate pushbutton on the sprayer assembly or using another appropriate input device (step 320). The operator then actuates an activation device, such as a trigger switch, to spray an atomized mist of tanning solution from the nozzle of the sprayer assembly (step 330). Next, the operator moves the sprayer assembly relative to the recipient's body to apply the solution as desired or as instructed by the recipient (step 340). During the spraying of the solution, the operator and/or the recipient determines if the intensity should be adjusted (step 350). For example, the operator or recipient can determine that a certain area of the body can require a darker or lighter shading than other areas to create contoured shading resulting in a natural looking tan. The operator can adjust the solution flow intensity accordingly during the operation (step 360). When the operator and/or recipient determines that the coating is complete (step 370), the operator can optionally select a spray intensity of zero to create an air-only spray (step 380). The operator can then move the sprayer assembly relative to the recipient's body to dry the skin (step 390). When the skin has been satisfactorily dried, the operator can then deactivate the fluid spraying system (step 400).

It will also be appreciated that the base unit 102 of the fluid spraying system 100 need not be in the form of a mobile cart. For example, in one embodiment, the base unit 102 could be a portable system that does not include wheels, but rather includes a carrying handle to allow a user to transport the fluid spraying system 100. Alternatively, the base unit 102 can be stationary or in other words, not portable. For example, the base unit 102 can be a booth having a door. The booth can also be an open design. The booth could house at least one fluid reservoir and would include a sprayer assembly (similar to the one described above) in fluid communication with the fluid reservoir via a hose. In this embodiment, a user could enter the booth and an operator could apply sunless tanning solution to the user's body using the sprayer assembly. In another embodiment, the booth can include stationary nozzles to automatically apply sunless tanning solution to the user's body, then the user can supplement or “touch up” the application by using the sprayer assembly. In either embodiment, the booth can include an optional fan or fans for removing residual spray.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus, and illustrative examples shown and described. Accordingly, departures can be made from such details without departing from the spirit or scope of the applicant's general inventive concept. The system is not designed solely for sunless tanning products or for the purpose of spraying a human body. It can accommodate almost any type of product being sprayed.

1. A sunless tanning system comprising:
a base unit having a reservoir configured to contain a sunless tanning solution; and
a handheld sprayer assembly in fluid communication with the reservoir, including:
an activation device configured to activate the sunless tanning system; and
a nozzle configured to eject sunless tanning solution onto an application surface upon activation of the sunless tanning system.

2. The sunless tanning system of claim 1, wherein the sprayer assembly includes an input device configured to adjust ejection intensity of the tanning solution through the nozzle.

3. The sunless tanning system of claim 2, wherein the input device is a plurality of pushbuttons.

4. The sunless tanning system of claim 1, wherein the activation device is further configured to adjust ejection intensity of the sunless tanning solution through the nozzle.

5. The sunless tanning system of claim 1, wherein the base is a mobile cart having a plurality of wheels and a handle.

6. The sunless tanning system of claim 1, wherein:
the nozzle is a hydraulic atomizing nozzle;
the base unit includes a high pressure pump configured to pump the tanning solution from the reservoir to the sprayer assembly; and
the sprayer assembly includes a valve configured to control ejection of the tanning solution through the hydraulic atomizing nozzle as an atomized mist.

7. The sunless tanning system of claim 1, wherein:
the nozzle is a HVLP atomizing nozzle;
the base unit includes an HVLP fan to provide high velocity/low pressure air flow to the sprayer assembly and a pump configured to pump the tanning solution from the reservoir to the sprayer assembly; and
the sprayer assembly includes a valve configured to control ejection of the tanning solution through the HVLP atomizing nozzle as an atomized mist.

8. The sunless tanning system of claim 1, further comprising:
a pump provided in the base unit and configured to pump the sunless tanning solution from the reservoir to the sprayer assembly;
an air tank and an air compressor provided in the base unit and in fluid communication with the handheld sprayer assembly;
an air valve provided in the base and configured to control the flow of compressed air to a mixing chamber provided in the handheld sprayer assembly;
a solution valve provided in the sprayer assembly and configured to control the flow of sunless tanning solution to the mixing chamber, wherein the sunless tanning solution mixes with the compressed air in the mixing chamber to create an atomized mist of tanning solution that is ejected through the nozzle.

9. The sunless tanning system of claim 8, further comprising an input device configured to cause only air to spray through the nozzle.

10. The sunless tanning system of claim 8, further comprising an attachment accessory configured to be removably attached to the nozzle, the attachment accessory includes an auxiliary fluid reservoir configured to contain an auxiliary fluid.

11. A handheld sprayer assembly configured to be in fluid communication with a fluid reservoir and an air tank, the assembly comprising:
a fluid valve;
an activation device configured to activate the handheld sprayer assembly by opening the fluid valve;
a nozzle configured to spray an atomized mist upon activation of the sprayer assembly; and
an input device configured to control spray intensity of the fluid through the nozzle.

12. The sprayer assembly of claim 11, wherein the input device is configured to cause only air to spray through the nozzle.

13. A fluid spraying system comprising:
a base unit including first and second fluid reservoirs;
a handheld sprayer assembly including an activation device and a nozzle in fluid communication with the plurality of reservoirs; and
a controller operably coupled to the activation device to control the spray of fluid through the nozzle of the handheld sprayer assembly.

14. The fluid spraying system of claim 13, wherein the base unit houses the controller.

15. The fluid spraying system of claim 13, wherein the handheld sprayer assembly further includes an input device operably coupled to the controller to adjust spray intensity of the fluid through the nozzle of the handheld sprayer assembly.

16. The fluid spraying system of claim 13, wherein the activation device is operably coupled to the controller and configured to adjust spray intensity of the fluid through the nozzle of the handheld sprayer assembly.

17. The fluid spraying system of claim 13, wherein the first and second fluid reservoirs hold a different fluid.

18. The fluid spraying system of claim 17, wherein the base unit includes an input device operably connected to the controller to adjust the ratio of the different fluids drawn from the first and second fluid reservoirs.

19. The fluid spraying system of claim 13, wherein the base unit further includes an air tank, an air compressor, and an air valve in fluid communication with the nozzle of the handheld sprayer assembly.

20. The fluid spraying system of claim 19, wherein the activation device is configured to signal the controller to open the air valve and to open at least one fluid valve provided in the sprayer assembly, thereby allowing air and fluid to mix in a mixing chamber provided in the sprayer assembly to create an atomized mist of fluid that is ejected from the nozzle.

21. The fluid spraying system of claim 19, wherein the handheld sprayer assembly further includes an input device operably connected to the controller to cause only air to spray through the nozzle.

22. The fluid spraying system of claim 13, further comprising an attachment accessory configured to be removably attached to the nozzle, the attachment accessory includes an auxiliary fluid reservoir configured to contain an auxiliary fluid.

23. A method of applying a sunless tanning solution to a body of a person, the method comprising:
providing a sunless tanning system comprising a sprayer assembly in fluid communication with a base housing a plurality of reservoirs;
selecting a tanning solution flow intensity;
activating the sunless tanning system to spray an atomized mist of the tanning solution through a nozzle of the sprayer assembly; and
moving the sprayer assembly relative to the body of the person to be coated.

24. The method of claim 22, further comprising the step of selecting a desired ratio of solutions from the plurality of reservoirs

25. The method of claim 22, further comprising the additional steps of:
selecting to spray only air through the nozzle from an air tank provided in the base; and
moving the sprayer assembly relative to the body of the person to dry the skin.
